(19) United States
(12) Patent Application Publication
(10) Pub. No.: US 2006/0012936 A1
(43) Pub. Date: Jan. 19, 2006

(54) Electronic apparatus

(76) Inventor: Byoung-in Choi, Yongin-si (KR)

Correspondence Address: STANZIONE & KIM, LLP, 919 18TH STREET, N.W., SUITE 440, WASHINGTON, DC, 20006, US

(21) Appl. No.: 11/159,103

(22) Filed: Jun. 23, 2005

(30) Foreign Application Priority Data
Jul. 14, 2004 (KR) 2004-54925

(51) Int. Cl. H02H 9/06

(52) U.S. Cl. 361/119

(57) ABSTRACT

An electronic apparatus includes a microcomputer, an IC communicating with the microcomputer through a predetermined communication line; and a transient current breaker preventing a predetermined transient current from being introduced from the microcomputer to the IC through the communication line. Thus an electronic apparatus which prevents a transient current from being introduced from a microcomputer to an adjacent integrated circuit is provided, thereby solving problems in telecommunication.

### CROSS-REFERENCE TO RELATED APPLICATIONS

This application claims the benefit of Korean Patent Application No. 2004-0054925, filed Jul. 14, 2004, in the Korean Intellectual Property Office, the disclosure of which is incorporated herein by reference.

### BACKGROUND OF THE INVENTION

1. Field of the Invention

The present general inventive concept relates to an electronic apparatus, and more particularly, to an electronic apparatus which prevents a transient current from being introduced from a microcomputer to an adjacent integrated circuit, thereby solving a problem in telecommunication.

2. Description of the Related Art

As shown in FIG. 1, an electronic apparatus generally comprises a microcomputer 100 controlling overall components thereof, and a plurality of adjacent integrated circuits (IC) 102, 104, 106 interactively communicating with the microcomputer 100.

When the electronic apparatus is turned on/off, the adjacent IC 102, 104 and 106 may instantly require a transient current according to their characteristics. In the case where the adjacent ICs 102, 104 and 106 instantly require the transient current, the transient current is introduced from the microcomputer 100 to the adjacent ICs 102, 104 and 106 through communication lines 108 and 110. Therefore, the microcomputer 100 deprived of the transient current is insufficient to operate, so that telecommunication is not smoothly performed.

### SUMMARY OF THE INVENTION

Accordingly, it is an aspect of the present general inventive concept to provide an electronic apparatus which prevents a transient current from being introduced from a microcomputer to an adjacent integrated circuit, thereby solving a problem in telecommunication.

Additional aspects and advantages of the present general inventive concept will be set forth in part in the description which follows and, in part, will be obvious from the description, or may be learned by practice of the general inventive concept.

The foregoing and/or other aspects and advantages of the present general inventive concept are achieved by providing an electronic apparatus comprising: a microcomputer; an IC communicating with the microcomputer through a predetermined communication line; and a transient current breaker preventing a predetermined transient current from being introduced from the microcomputer to the IC through the communication line.

According to an embodiment of the present general inventive concept, the transient current breaker can be disposed on the communication line, and can comprise a diode having a cathode connected to the microcomputer and an anode connected to the IC.

According to an embodiment of the present general inventive concept, the electronic apparatus may further comprise a pull-up circuit disposed between the anode of the diode and the IC, and pulls up the communication line between the anode of the diode and the IC when a high signal is applied to the cathode of the diode.

### BRIEF DESCRIPTION OF THE DRAWINGS

The above and/or other aspects and advantages of the present general inventive concept will become apparent and more readily appreciated from the following description of the embodiments, taken in conjunction with the accompany drawings of which:

FIG. 1 is a view showing an internal configuration of a conventional electronic apparatus; and

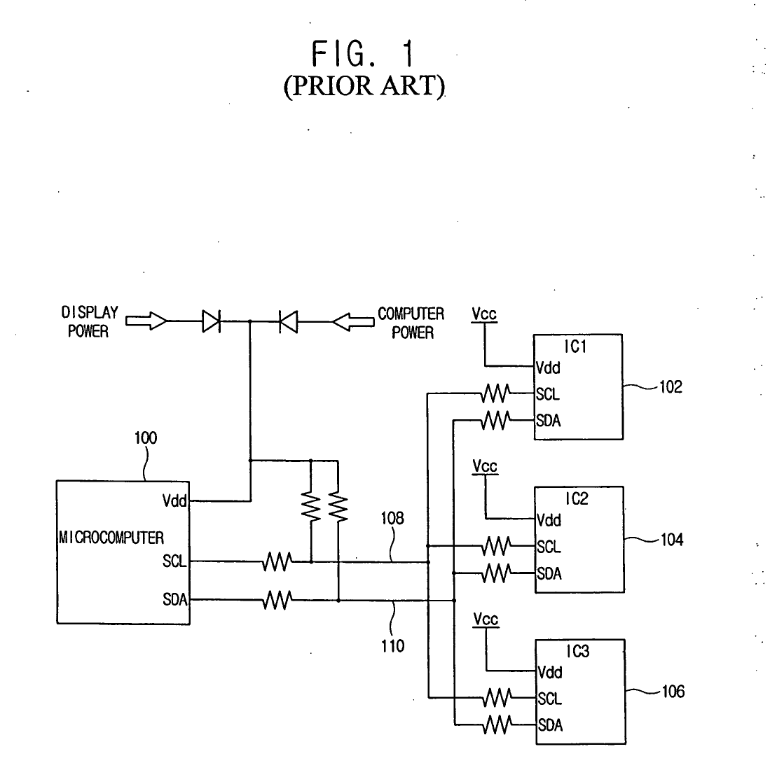

FIG. 2 is a view showing an internal configuration of an electronic apparatus according to an embodiment of the present general inventive concept.

### DETAILED DESCRIPTION OF THE PREFERRED EMBODIMENTS

Reference will now be made in detail to the embodiments of the present general inventive concept, examples of which are illustrated in the accompanying drawings, wherein like reference numerals refer to like elements throughout. The embodiments are described below in order to explain the present general inventive concept by referring to the figures.

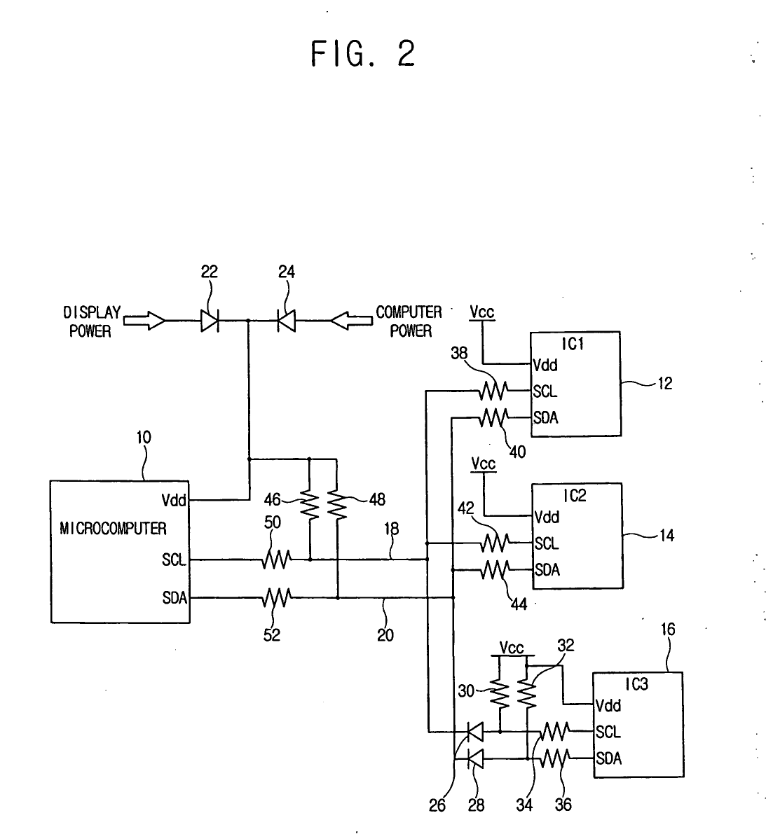

FIG. 2 is a view showing an internal configuration of an electronic apparatus according to an embodiment of the present general inventive concept.

As shown in FIG. 2, an electronic apparatus according to an embodiment of the present general inventive concept comprises a microcomputer 10 controlling overall components thereof, and a plurality of adjacent integrated circuits (IC) 12, 14 and 16 interactively communicating with the microcomputer 10. Here, the microcomputer 10 and the adjacent ICs 12, 14 and 16 interactively communicate with each other through I²C communication lines 18 and 20.

According to an embodiment of the present general inventive concept, the electronic apparatus includes a display apparatus connected to a computer and receiving electric power from the computer.

The microcomputer 10 comprises a Vdd port to receive the electric power, and SCL and SDA ports forming the I²C communication lines 18 and 20.

The Vdd port of the microcomputer 10 is used to receive the electric power from the display apparatus or the computer, wherein the electric power passes through a diode 22 or 24.

The SCL port and the SDA port of the microcomputer 10 are connected to an SCL port and an SDA port of the adjacent ICs 12, 14 and 16, respectively, thereby forming the I²C communication lines 18 and 20. On the I²C communication lines 18 and 20 are provided series resistors 34, 36, 38, 40, 42, 44, 50 and 52 to limit electric current flow.

Further, the electronic apparatus comprises pull-up resistors 30 and 32 to pull up the I²C communication lines 18 and 20 when the telecommunication is not performed through the I²C communication lines 18 and 20.

When the transient current is introduced from the microcomputer 100 of the conventional electronic apparatus to the adjacent IC3 16, a problem can arise in the telecommunication.

Thus, according to an embodiment of the present general inventive concept, when the electric power is supplied from the display apparatus or the computer, high voltage is applied to cathodes of diodes 26 and 28, the diodes 26 and 28 being connected to a side of the IC3 16 such that anode ends of the diodes 26 and 28 are connected to the IC3 16. At this time, the diodes 26 and 28 become reverse-biased and behave like an open switch. Thus, when the power is turned on/off, the transient current is not instantly introduced to the adjacent IC3 16 through the I²C communication lines 18 and 20.

Further, at this time, the pull-up resistors 30 and 32 cause the Vcc high voltage to be applied to the SCL port and the SDA port of the IC3 16. That is, the pull-up resistors 30 and 32 function as a pull-up circuit to pull up the communication lines 18 and 20 between the respective diodes 26 and 28 and the IC3 16. Therefore, the electric current is not introduced to the IC3 16 through the I²C communication lines 18 and 20, but through the pull-up resistors 30 and 32.

The pull-up circuit comprising the diodes 26 and 28 and the pull-up resistors 30 and 32 is disposed in a front terminal of the IC having a problem in the I²C communication and does not have an effect on the other ICs. For example, the pull-up circuit can be applied to only a line having the problem between SCL and SDA lines. Accordingly, the pull-up circuit comprising the diodes 26 and 28 and the resistors 30 and 32 illustrated in FIG. 2 can be applied to any one of or a plurality of the ICs used with the electronic apparatus.

In the foregoing embodiment, the series resistors 34 and 36 are disposed in the front terminal of the IC3 16. However, the series resistors 34 and 36 may be disposed in a front terminal or a back terminal of the pull-up resistors 30 and 32.

As described above, the present general inventive concept provides an electronic apparatus, which prevents a transient current from being introduced from a microcomputer to an adjacent integrated circuit, thereby solving problems in telecommunication.

Although a few embodiments of the present general inventive concept have been shown and described, it will be appreciated by those skilled in the art that changes may be made in these embodiments without departing from the principles and spirit of the general inventive concept, the scope of which is defined in the appended claims and their equivalents.

What is claimed is:

1. An electronic apparatus comprising:
a microcomputer;
an IC (integrated circuit) communicating with the microcomputer through a predetermined communication line; and
a transient current breaker preventing a predetermined transient current from being introduced from the microcomputer to the IC through the communication line.

2. The electronic apparatus according to claim 1, wherein the transient current breaker is disposed on the communication line, and comprises a diode having a cathode connected to the microcomputer and an anode connected to the IC.

3. The electronic apparatus according to claim 2, further comprising a pull-up circuit disposed between the anode of the diode and the IC, and pulls up the communication line between the anode of the diode and the IC when a high signal is applied to the cathode of the diode.

4. An electronic apparatus comprising:
a microcomputer to control components of the electronic apparatus;
a plurality of integrated circuits (ICs) to communicate with the microcomputer;
communication lines providing the communication between each of the ICs and the microcomputer; and
a transient current restrictor associated with at least one of the ICs to restrict transient current from being instantly introduced to the respective IC through the communication lines when power is turned on/off.

5. The electronic apparatus of claim 4, wherein the transient current restrictor comprises a diode provided at each communication line of the at least one IC, the diode having an anode end connected to the IC and a cathode end connected to the microcomputer.

6. The electronic apparatus of claim 5, further comprising a pull-up circuit connected between the anode end and the IC to pull-up the communication lines when telecommunication is not performed therethrough.

7. The electronic apparatus of claim 6, wherein the pull-up circuit comprises:
a voltage source connected to the anode end of each diode; and
a resistor connected between the voltage source and the anode end of each diode.

8. A method of restricting transient current within an electronic apparatus including a microcomputer and plural integrated circuits (ICs), the method comprising:
providing communication lines between each of the ICs and the microcomputer to allow communication therebetween; and
providing a transient current breaker at each of the communication lines between at least one of the ICs and the microcomputer to prevent transient current from flowing to the at least one IC from the microcomputer, a first end of the transient current breaker being connected to the microcomputer and a second end of the transient current breaker being connected to the at least one IC.

9. The method according to claim 8, further comprising:
providing a pull-up circuit between the second end of the transient current breaker and the respective IC to pull-up the communication line when a high voltage is applied from the microcomputer.
